(19) United States
(12) Patent Application Publication
(10) Pub. No.: US 2002/0039112 A1
(43) Pub. Date: Apr. 4, 2002

(54) Collecting information from respondents to supply back to originators

(76) Inventor: Julian S. May, Klosters (CH)

Correspondence Address: HARNESS, DICKEY & PIERCE, P.L.C., P.O. BOX 828, BLOOMFIELD HILLS, MI, 48303, US

(21) Appl. No.: 09/970,227

(22) Filed: Oct. 3, 2001

(30) Foreign Application Priority Data
Oct. 4, 2000 (GB) 0024225.5

(51) Int. Cl. G06F 7/00

(52) U.S. Cl. 345/700; 707/1

(57) ABSTRACT

A distribution server (131 ) collects information from respondents (103) so as to supply the information back to originators (102). Details of a form and a list of potential respondents are received from a plurality of originators (102, 109). A plurality of individual invitations based on a respective list for each of the plurality of originators is constructed by the server. Each invitation is supplied to potential respondents (103 to 107) inviting the potential respondents to complete a form of the type generated by a respective originator. First responses are received by the server (131 ) from actual respondents, some of which affirm an acceptance to complete a form. The server (131) supplies a form to each of the actual respondents. Second responses are received from the actual responses containing response data. The response data is stored and stored data is returned to respective originators.

### BACKGROUND OF THE INVENTION

1. Field of the Invention

The present invention relates to collecting information from a plurality of respondents connected to an internet by the submission of electronic forms.

2. Description of the Related Art

Over the Internet, it is well known to serve blank forms to respondents, such that they may complete these forms on their own computer and then return them electronically back with relevant information added thereto. Forms of this type are regularly used by online insurance brokers for example where, in response to the information given in the form, it is possible for insurance quotes to be given, whereafter a respondent may take up an offer of insurance or whatever other service is being provided.

It is known for forms of this type to be generated using hypertext mark-up language (HTML) and it is also known that the amount of development work invested in form development of this type may be quite considerable. Thus, for example, a new internet bank may spend millions of dollars developing a new website for the provision of financial services. This expenditure is justified in that the bank is hoping to attract a substantially large number of customers, each requesting and paying for financial services. Thus, over a period of time, the bank's investment is returned many times over. Furthermore, the bank may be able to make other savings elsewhere in that the provision of physical banking facilities or the provision of telephone banking facilities may be reduced in favour of the on-line internet connection.

It has also been appreciated that forms of this type could be used for many other purposes where the value of each individual form may be less than that anticipated by financial institutions etc and where the period over which the form remains useful may also be significantly less than that for the forms used in financial applications etc. In these circumstances, although it would be desirable to use HTML forms of the aforesaid type, the development cost is not justified by the anticipated financial return. However, it has been appreciated that a demand exists for providing facilities of this type such that, for example, a marketing department or organisation conducting customer satisfaction surveys may be able to collect information electronically without major expenditure in terms of developing websites etc. Furthermore, it has also been appreciated that it would be desirable to allow information collecting activities of this type to be established using existing personnel, such that the degree of technical knowledge and experience can be relatively minimal.

### BRIEF SUMMARY OF THE INVENTION

According to a first aspect of the present invention, there is provided serving apparatus configured to collect information from respondents so as to supply said information back to originators, comprising receiving means for receiving details of a form and a list of potential respondents from a plurality of originators; constructing means for constructing a plurality of individual invitations based on a respective list for each of said plurality of originators; supplying means for supplying each invitation to potential respondents inviting said potential respondents to complete a form of the type generated by a respective originator; wherein said receiving means receives first responses from actual respondents, some of which affirm an acceptance to complete a form; said supplying means supplies a displayable form to each actual respondent; said receiving means receives second responses from said actual respondents containing response data; storing means stores said response data from respondent; and returning means returns collected information to respective originators.

### BRIEF DESCRIPTION OF SEVERAL VIEWS OF THE DRAWINGS

FIG. 1 shows an operational environment for a preferred embodiment of the invention;

FIG. 2 shows a logical representation of procedures performed within the environment of FIG. 1;

FIG. 3 illustrates scheduling operations performed by the server shown in FIG. 1;

FIG. 4 illustrates an originator's computer system;

FIG. 5 illustrates an arrangement of program instructions and data stored within the memory of the system shown in FIG. 4;

FIG. 6 illustrates operations performed by the systems of form-originators;

FIG. 7 shows a process for the preparation of new forms identified in FIG. 6;

FIG. 8 shows a graphical user interface displayed to a form operator under the procedures illustrated in FIG. 7;

FIG. 9 details a window forming part of the graphical user interface shown in FIG. 8;

FIG. 10 shows an example of a form created within a canvas window identified in FIG. 8;

FIG. 11 illustrates a database table;

FIG. 12 details procedures for populating the database table shown in FIG. 11;

FIG. 13 details the distribution server shown in FIG. 1;

FIG. 14 details hardware constituents of the processor identified in FIG. 13;

FIG. 15 summarises executable instructions stored within the memory shown in FIG. 14;

FIG. 16 illustrates operations performed by the server shown in FIG. 14;

FIG. 17 details procedures for the establishment of new records;

FIG. 18 details procedures for the distribution of email messages, identified in FIG. 16;

FIG. 19 details procedures for processing returned data, identified in FIG. 16; and

FIG. 20 shows an example of a summary report generated by an originators application.

### BEST MODE FOR CARRYING OUT THE INVENTION

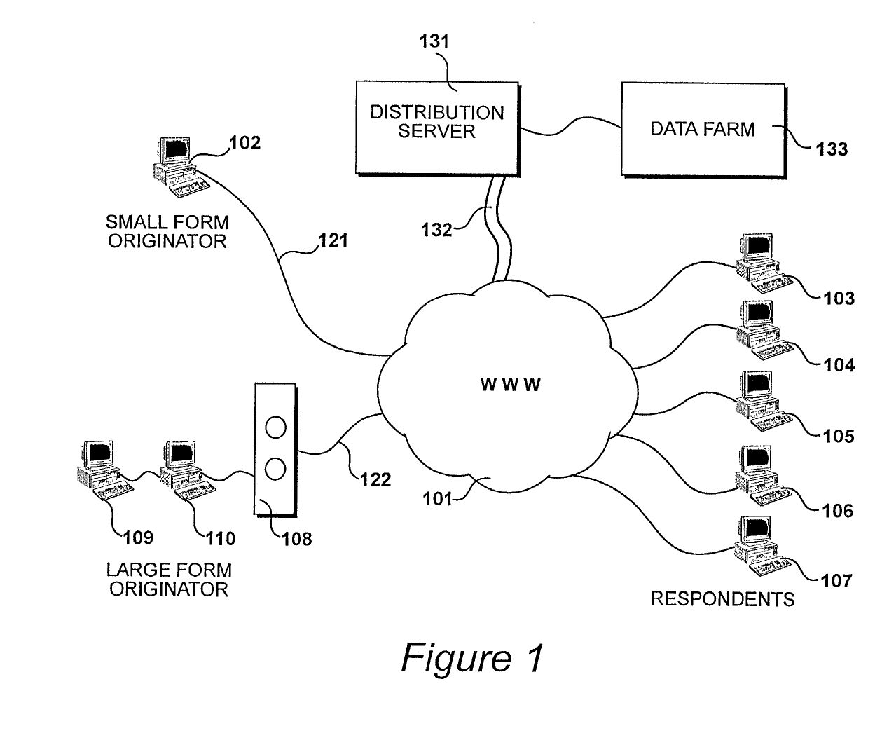

A preferred embodiment of the present invention operates within the environment World Wide Web 101, as shown in FIG. 1. A manufacturing and distribution company uses the World Wide Web to obtain sales related information from its customers and its potential customers. This is achieved by submitting electronic forms over the World Wide Web 101 with an invitation for a recipient to complete the form and then return it. The organisation has a single computer terminal 102 connected to the Web 101 and as such may be considered as a small form-originator. The small form-originator 101 has developed a relatively small database of customers and this database may be interrogated when new forms are being distributed. Similarly, information may be added to the database when a recipient responds to a form and may therefore be considered as a respondent, such as respondents 103, 104, 105, 106 and 107.

In addition, a financial institution has a mainframe computer 108 connected to the Web 101 with computer terminals 109 and 110 connected to said mainframe computer 108. The mainframe computer 108 maintains a relatively large database. Forms originate at computer terminals 109 and 110, are despatched in electronic form and are then received from respondents, such as respondents 103 to 107.

Computer terminals 102, 109 and 110 may each be used for originating a form and as such may be considered as form-originators. Conventionally, in order to originate a form, the form itself must be defined in an appropriate programming language and, conventionally, for distribution over the World Wide Web, the forms are generated using hypertext mark-up language (HTML). Consequently, skilled HTML programmers are required in order to generate appropriate forms, thereby making the operation a relatively expensive exercise. In this example, the exercise is often justified, particularly for the large form-originator, employing staff specifically for this purpose. The situation is different for the small form-originator who cannot justify an in-house capability and is therefore required to use external consultants. A problem exists at the small form-originator in that many situations arise where it would be desirable to obtain feedback from customers using electronic forms but the benefits cannot be justified with respect to the costs involved, resulting in much useful marketing information being lost.

The attitude of respondents in terms of completing forms and then returning them back to an originator may vary significantly but three basic types of response may be considered, as follows:

i. The recipient completes the form and returns it to the originator, thereby becoming an effective respondent.

ii. The recipient does nothing and no response is returned.

iii. The recipient refuses to file a response and also provides an indication that no further communications of similar type should be submitted.

In many applications, the distribution of forms will be unsolicited and some respondents may not wish to obtain unsolicited communications of this type. Recently, there has been a tendency towards introducing legislation under which it may become an offence if, having been told that mail of this type is not required, an originator continues to despatch it. Consequently, maintaining records based on who has expressed a wish not to receive mail of this type becomes a further burden placed upon the form-originators.

In many applications, the number of potential respondents contacted may be relatively large. In this example, the small form-originator, using terminal 102, wishes to prompt a response from ten thousand respondents. A similar exercise is being performed by the large form-originator, using terminal 109, but on this occasion it is intended to contact one hundred thousand potential respondents. Computer terminal 102 uses a conventional telephone line 121 to connect with the World Wide Web 101. Mainframe computer 109 has an ISDN connection 122 for communicating with the World Wide Web. It should therefore be appreciated that if computer terminal 102 is to despatch ten thousand e-mails over a telephone line and mainframe computer 108 is to despatch one hundred thousand e-mails over an ISDN connection, the amount of time taken for these communications to take place becomes relatively large. During the process, it is likely that someone would need to oversee the operation and, furthermore, communication lines 121 and 122 would be inaccessible to other users of the system.

To summarise, a form-originator is presented with three fundamental problems in terms of sending a large number of forms out to potential respondents. Firstly, there is the overhead of generating the form in the first place, usually requiring skilled personnel. Secondly, there is a further problem of transmitting a generated form to a relatively large number of respondents. Thirdly, there is a further risk in that an originator may inadvertently send a form to a respondent who has previously expressed a desire not to receive the form again.

The present embodiment overcomes these problems by the provisions of an independent serving apparatus 131, having a high bandwidth communications link to the World Wide Web 132 and preferably provided with data farming capacity 133.

Distribution server 131 facilitates the distribution of forms to respondents 103 to 107 for a plurality of form-originators 102, 109. In addition, each form-originator may originate a plurality of different campaigns, wherein each of said campaign contacts a plurality of respondents. Different campaigns from the same originator may be addressed to the same set of respondents or, alternatively, different campaigns may have different sets of respondents.

The distribution server 131 makes an application available to originators to facilitate the generation of forms using user-friendly drag and drop techniques. In this way, it is not necessary for an originator to be skilled in the use of form generation using HTML (or any other sophisticated language). The application is specifically designed for the generation of forms in an environment where individual form components may be selected from a displayed menu.

It should be understood that the distribution server makes an application available to originators but once received by an originator, the application is then executed on the originators'terminals, such as terminal 102. The application is preferably received by the distribution server, in order to ensure that up to date versions are received. However, versions of this application could be received by other means, such as free CD ROMS distributed by magazines etc.

The form-originators, having received this application, generate a form and thereafter append to it a list of potential respondents. This is then returned back to the distribution server 131, such that the distribution server receives details of a particular form and a list of potential respondents. This collection of information, from the server's perspective, may be considered as a job. Information from an originator constituting a single job is supplied to the distribution server 131 as a single e-mail message. Thus, although one hundred thousand, say, potential respondents may be identified in the job, all of this information is conveyed to the distribution server as a single message and as such the amount of time taken for this transfer to occur is relatively short, compared to the time taken for individual e-mails to individual respondents to be despatched.

At the distribution server 131, the individual invitations are constructed based on a respective list of respondents. Thereafter, each invitation is supplied to potential respondents, inviting the potential respondents to complete a form of a type generated by the respective originator. This transfer of individual e-mails to potential respondents is conveyed over a high bandwidth communication channel 132, such that the time taken for the transfer to take place is relatively small, compared to a transfer of this type taking place over channels 121 or 122. Furthermore, the bandwidth of channel 132 is such as to allow e-mails generated for many jobs, that may in turn be generated from many originators, to be despatched in a multiplexed fashion.

When responses are returned from respondents, they are stored at the distribution server 131 and then this collected information may be grouped together and returned to respective originators.

Fundamentally, the process of generating a form involves substantially less effort on the part of the form-originators and may therefore be included as part of conventional clerical activities. Furthermore, the bandwidth required for the information to be transferred from the form-originators, in terms of questionnaires going out and completed forms coming back, is significantly reduced. The individual transmission of forms on a one-by-one basis is performed by the distribution server 131 over the high bandwidth communication channel 132. When communications occur with the form-originators, such as originator 102, individual responses are grouped together thereby allowing substantially more information to be transferred by a single transmission. The information is also compressed and encrypted when being transferred between the server and form-originators.

It will be appreciated that the server is provided with a significantly larger bandwidth communication channel to the Internet when compared to the majority of form originators. The form originators effectively provide a single instruction to the server from which many forms may be distributed. The relatively low bandwidth originators are therefore effectively leasing time on the high bandwidth form distribution server.

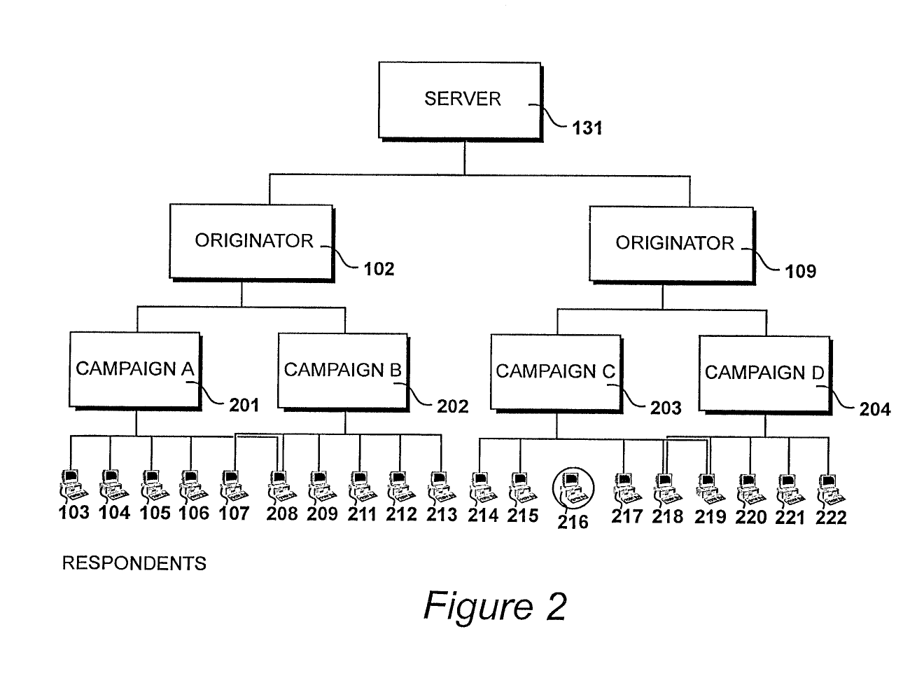

A logical representation of procedures performed within the environment of FIG. 1 is illustrated in FIG. 2. Originator 102 establishes campaign A 201 requiring a distribution to ten thousand respondents 103 etc. In addition, campaign B 202 is initiated in which twenty thousand respondents are contacted. In parallel with this, originator 109 has initiated campaign C 203 for one hundred thousand respondents, along with campaign D 204 for one hundred and fifty thousand respondents. Limited examples, 103 to 107 and 208 to 222 are identified as respondents in FIG. 2.

Although campaign 202 is larger than campaign 201, there is some degree of overlap and some respondents will be part of both campaigns. Thus, in the example shown in FIG. 2, respondents 107 and 208 are contacted by both campaign 201 and campaign 202. Similarly, respondents 218 and 219 are contacted by campaign 203 and campaign 204. On a previous campaign, respondent 216 has expressed a desire to the effect that unsolicited mail is not to be sent from originator 109. Server 131 is aware of this fact therefore although respondent 216 has appeared on a database of respondents generated by originator 109, this respondent has not been contacted by campaign 203 or by campaign 204.

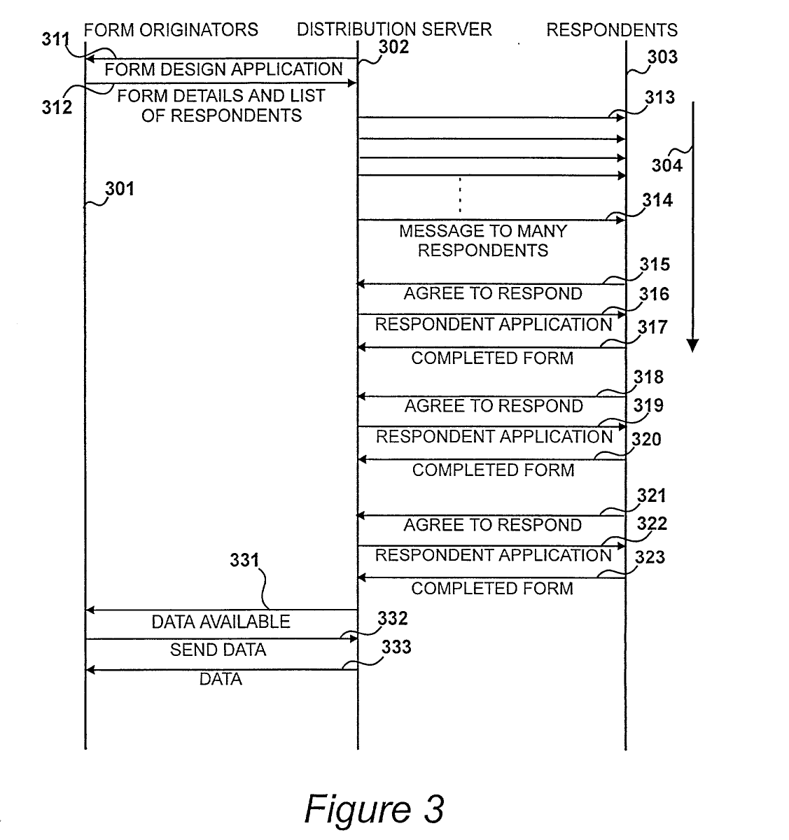

It can be seen from FIG. 2 that server 131 needs to co-ordinate the distribution of e-mail enquiries and the receipt of completed forms for many originators, each of which may be involved with several campaigns or jobs and each of which may be establishing communications with many respondents. An example of scheduling operations performed by the server, over a period of time, is illustrated in FIG. 3. Line 301 represents form-originators, line 302 represents the distribution server 131 and line 303 represents respondents 103 etc. Operations are performed over time in the direction of arrow 304. Operations performed over the period of time illustrated in FIG. 3 represents a single job and also represents transactions with three respondents within the single job. Thus, it can be appreciated that server 131 conducts an extremely large number of transactions of the type illustrated in FIG. 3, with many originators and many jobs being multiplexed.

A relationship with an originator 301 is initiated by a form design application being transferred from the distribution server 301 to the originator, as illustrated by line 311. A form design application is transferred to a new originator and may be transferred again if an update to the application is made. Thus, although the form application is required initially, once received it may be used for the development of many form designs.

Form details and a list of respondents are transmitted to the distribution server as illustrated by line 312. The distribution server processes the form details and the list of respondents to generate a message to many potential respondents, as illustrated by lines 313 to 314.

A particular respondent agrees to respond, as illustrated by line 315, whereafter a respondent application is transmitted to the respondent, as illustrated by line 316. A completed form is then returned from the respondent back to the distribution server as illustrated by line 317.

A further respondent agrees to respond as illustrated by line 318. The respondent application is transmitted to the respondent as illustrated by line 319 and a completed form is then returned as illustrated by line 320. A further example of this transaction is illustrated by lines 321, 322 and 323 and it can be appreciated that this process will be repeated many times as communications are established between the server and the respondents.

Eventually, the server will inform the originator to the effect that data is available, as illustrated by line 331. The originator will then acknowledge that data is to be sent as illustrated by line 332 and the actual transmission of data then occurs, as illustrated by line 333.

FIG. 3 represents a modest level of transmission activity but it quickly becomes apparent that the bulk of the transmission and activity occurs between the distribution server and the respondents. The distribution server has a high bandwidth communication link 132 to the Web and communicates with many respondents. Thus, although a large number of transactions are taking place, this does not place any strain on the availability of bandwidth. Transmission bandwidth is a limiting factor in terms of transmissions between form-originators and the distribution server. However, as far as communication here is concerned, the number of transactions is relatively small.

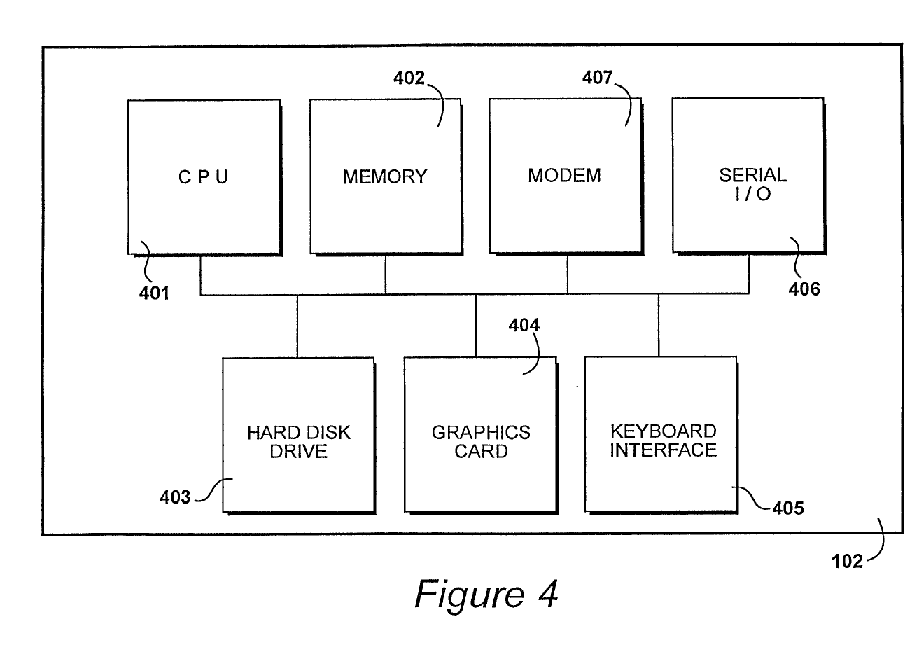

An originators' computer system 102 is illustrated in FIG. 4. The computer system includes a central processing unit 401, typically an Intel based device, having sixty-four megabytes of system memory 402. The computer system has a hard disk drive 403, a graphics card 404 for communicating with its monitor, a keyboard interface 405, a serial interface 406 and a modem 407. Modem 407 provides communication with the World Wide Web over communications channel 121.

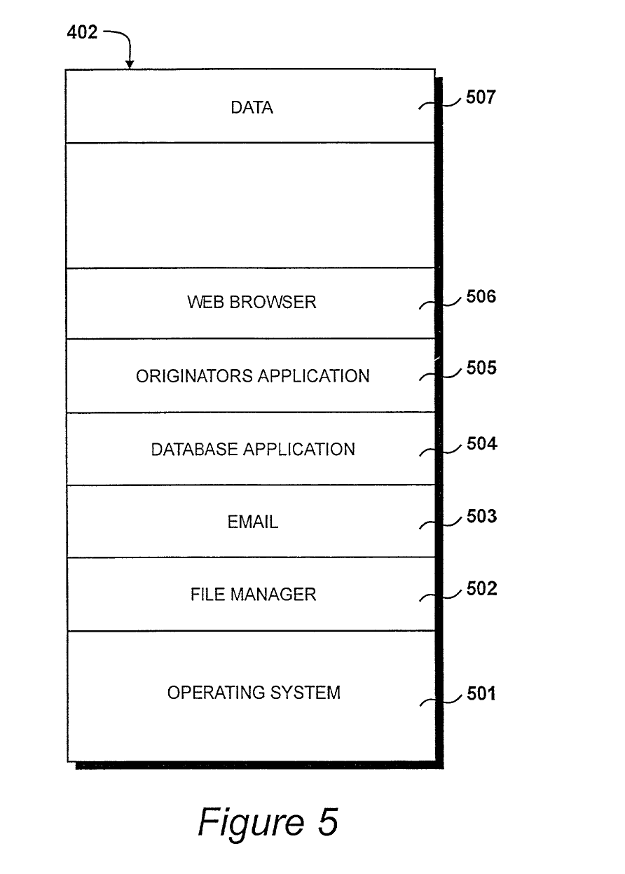

The arrangement of program instructions and data stored within memory 402 is illustrated in FIG. 5. An operating system such as Windows 2000 501 is included along with a file manager 502, an e-mail facility 503, a database application 504, an originator's application 505 and a Web browser 506. Initially, the originator's application 505 is received from the distribution server, as illustrated by line 311 of FIG. 3. Thereafter, the originator's application may be retained on hard disk drive 403 and loaded when required. Over time, registered originators would be supplied with updated versions of the originator's application and various versions of the applications may be made available for particular customer requirements.

During the generation of a particular form, data defining the properties of a form are written to a database retained with data storage area 507. This database reflects the nature of the form itself and is different from database applications identifying lists of respondents. In terms of supplying a list of respondents, data may be read from hard disk drive 403 under the control of database application 504.

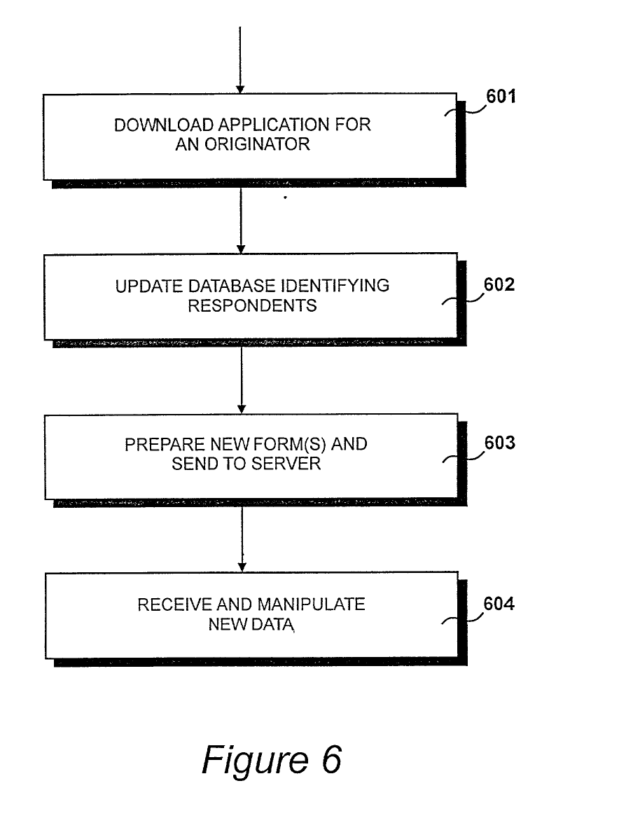

Operations performed by the systems of form-originators, such as system 102, are illustrated in FIG. 6. At step 601 a form generating application for an originator is downloaded from the server 131. This process may be performed once, although subsequent downloads may occur when updates become available.

At step 602 a database identifying respondents is updated, possibly in preparation for initiating a new campaign or when details of new respondents have been obtained. For small originators, such as originator 102, the database is retained locally on hard disk drive 403. For larger form-originators, a database may be retained using a local networked server 108.

At step 603 new forms are prepared using the downloaded application and then sent to the server 131 for distribution to respondents.

At step 604 data is received back from the distribution server in compressed and encrypted form. Manipulations are performed upon this received data, initially to de-encrypt and decompress it, whereafter further manipulations may be made to populate databases and perform statistical analyses.

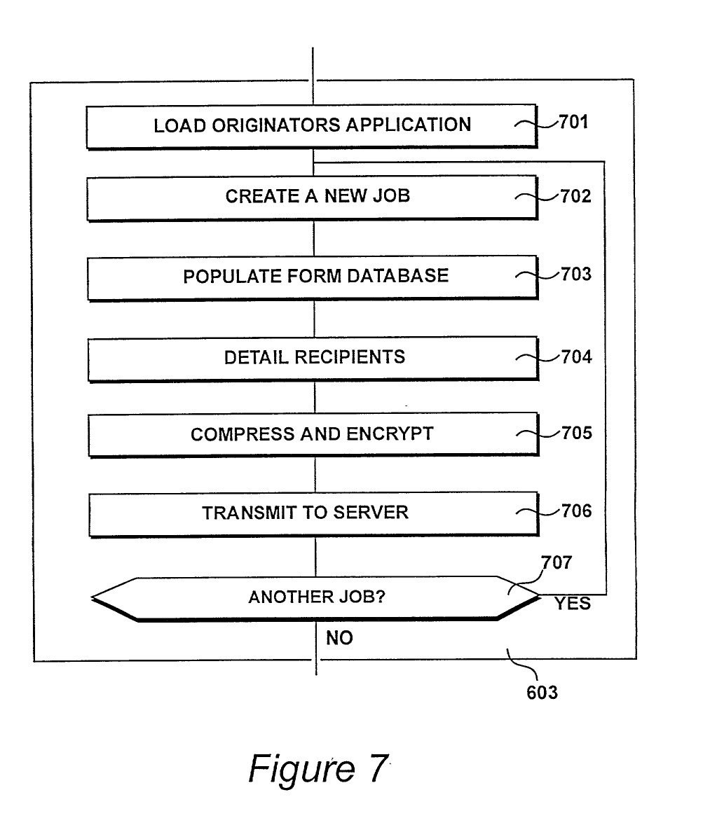

Process 603 for the preparation of new forms is detailed in FIG. 7. At step 701 the originator's application is loaded and at step 702 an instruction is generated to the effect that a new job is to be created. A form database is established and this database is populated as the form is constructed using a graphical-user interface.

After defining a form, details of recipients are established at step 704 whereafter the totality of the job, in terms of the form and the recipients, is compressed and encrypted at step 705. At step 706 the compressed and encrypted job is transmitted to the server 131, whereafter at step 707 a question is asked as to whether another job is to be created. When answered in the affirmative, control is returned to step 702.

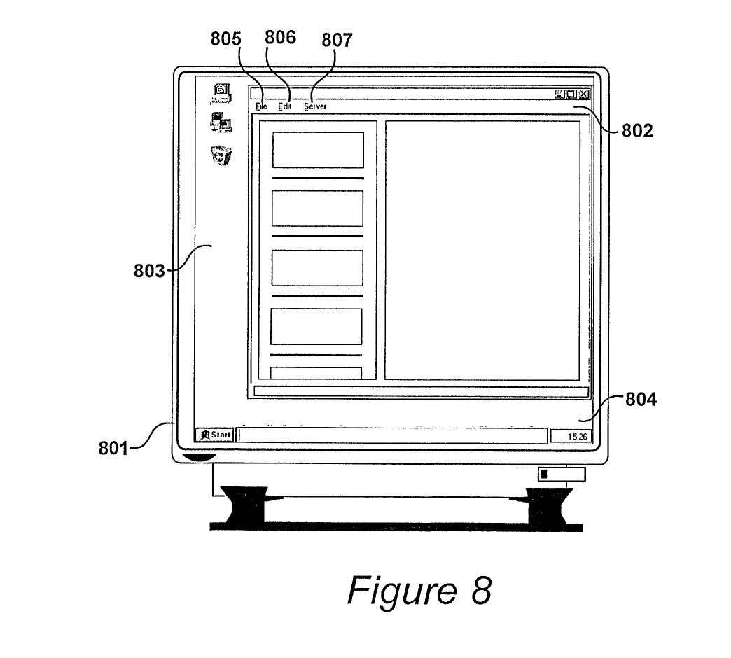

As shown in FIG. 8, system 102 includes a monitor 801 interfaced to graphics card 404. Upon loading the originator's application at step 701, the application presents a graphical-user interface comprising a menu bar 802, a first window 803 and a second window 804. The menu bar 802 includes a pull-down menu referenced “File” 805 for selecting functions relating to the local manipulation of data files. In addition, menu bar 802 includes a pull-down menu labelled “Edit” 806 relating to functions for the editing of a particular job being viewed. The menu bar 802 also includes a pull-down menu “Server” 807 relating to transactions with the server 131.

Window 803 identifies classes of form components that may be selected, by a process of dragging and dropping as particular instantiations within a form. Window 804 effectively presents a canvas on which the form is created by dragging and dropping form components from window 803.

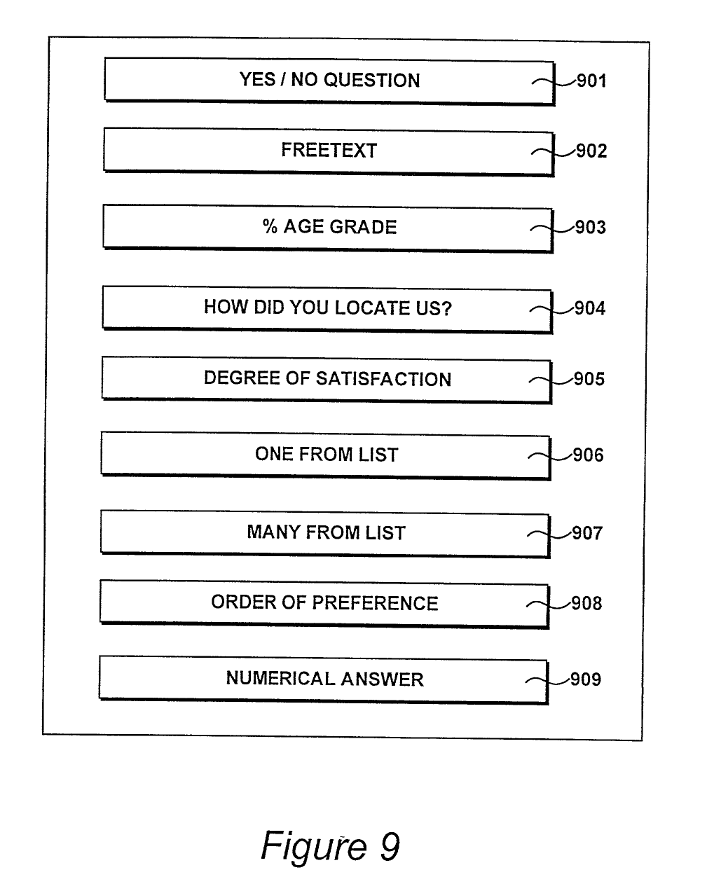

Window 803 is detailed in FIG. 9, showing examples of specific form components. Each form component 901 to 908 is individually selected by positioning a cursor over its location, placing a mouse button into pressure and then dragging an icon into the canvas window 804, thereby creating a copy of the object within the canvas. Object 901 allows a yes/no question to be defined in which a respondent is invited to answer a question either as a yes or a no.

Object 902 allows free text to be specified within the form. Such an object may be used, for example, where none of the more quantitative objects are appropriate for a particular operation.

Object 903 allows a percentage grade to be given, usually in response to some form of graphical manipulation.

Object 904 allows a specific question to be asked in response to which a specific answer is given from a predefined list.

Object 905 asks a specific question, such as degree of satisfaction, requiring a graphical representation to be specified.

Object 906 is a more generic form of object 904 allowing specific list entries to be given.

Object 907 is similar to object 906 but allows many possibilities from a list to be selected as distinct from only one.

Object 908 allows specific possibilities to be placed in an order of preference.

Object 909 allows a question to be constructed in response to which a numerical answer is expected.

After dragging and dropping an object for creation within the canvas 804, double clicking on the object opens a dialog box such that, where required, additional text may be added in order to complete the question. Closing the dialog box then ensures that the question is appropriately placed within the form, around the location onto which the original icon was dropped.

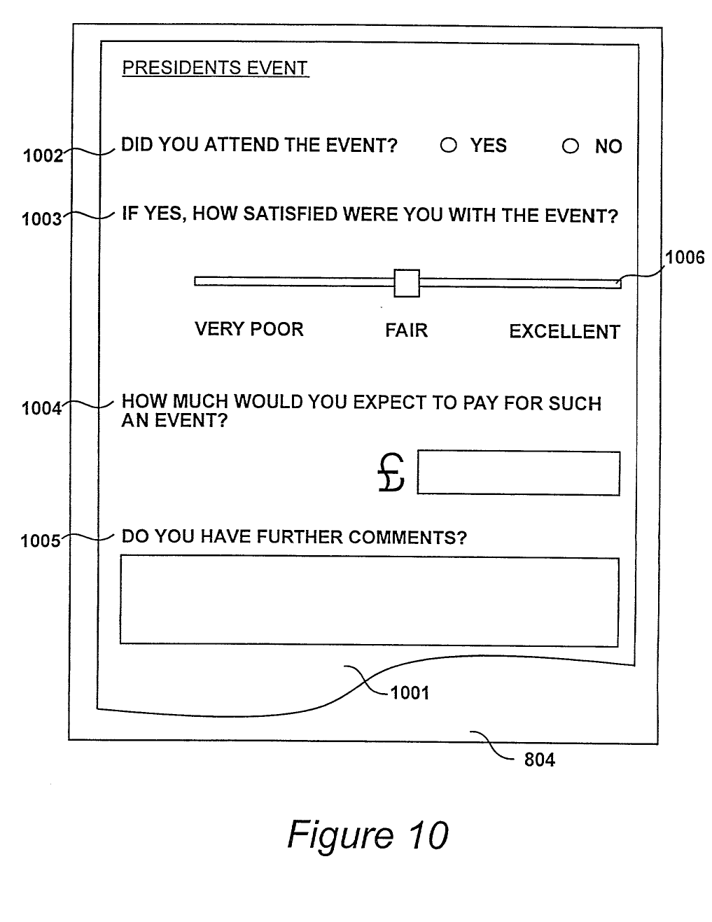

An example of a form 101 created within canvas window 804 is illustrated in FIG. 10. The form defines a marketing questionnaire to be sent out to respondents invited to a particular event. The campaign does not generate revenue in itself and the originator's budget is relatively small. The purpose of the campaign is to analyse the results returned so as to optimise expenditure for the next event.

At location 1002 a question has been asked as to whether the respondent attended the event. The respondent is then invited to answer this question with a yes or a no. This question has been created by selecting yes/no object 901 and then typing the specific question.

At location 1003 a question is asked to how satisfied was the respondent with the event, assuming the first question has been answered with a yes. This question has been generated by degree of satisfaction object 905 and only requires the form creator to enter the specific language of the question. A graphical slide bar 1006 is then automatically created, allowing a respondent to select the slide bar using a mouse and to position it on a range of possibilities from very poor to excellent.

At location 1004 a question is asked as to how much would the respondent expect to pay for an event of the particular type. The respondent would then be invited to enter a particular sum of money. This question is generated by selecting object 909 requiring a numerical answer. Thus, the question is programmed to the extent that if a respondent enters something other than a numerical value, an error message will be generated. Finally, at position 1005 the respondent is invited to add any further comments. Thus, in order to allow the respondent to add comments, a free text function has been created by the selection of object 902.

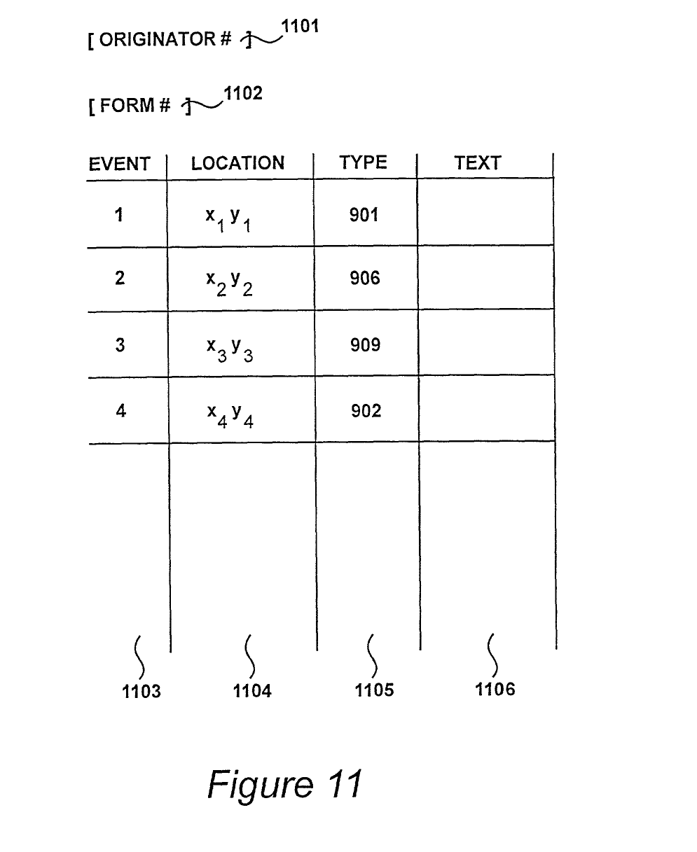

Having generated a form 1001 of the type shown in FIG. 10, it would be possible to process this information to generate a standard HTML version that could be sent out to respondents. However, it is desirable to minimise the amount of data transmitted from originators to the server and, given that the server is fully familiar with the type of forms being generated, it is possible to transfer the information in a substantially more efficient manner, whereafter HTML versions of the form, for distribution to respondents, may be transmitted using specific respondent Java Applets generated by the server 131. Information transmitted from originators to the server is therefore effected using database tables of the type shown in FIG. 11. The use of Java Applets also allows more sophisticated and user-friendly forms to be developed in preference to using basic HTML.

The database table includes a unique reference 1101 identifying the specific originator. A further reference number 1102 is unique to the specific job and is identified as a form number.

The database table includes a first field 1103 identifying a unique event number. A second field 1104 identifies the location of the event. A third field 1105 identifies the type of the event and a fourth field 1106 identifies any text associated with the event type.

Using the examples shown, event one would identify a 901 type event positioned towards the top of the form and including the text “Did you attend the event?”. Similarly, event number two is located slightly lower down the form and includes a 905 type event with associated text stating “If yes, how satisfied were you with the event?”.

Event number three is located around the centre of the form and is a 909 type event with text that states “How much would you expect to pay for such an event?”.

Event number four is positioned towards the bottom of the form and is of a type 902 with text “Any comments?”.

Thus, given that applications executed by both originators and the server are both aware of the way in which forms are constructed and from which form component objects, it is possible to detail the contents of the form using a relatively small amount of information, as shown in the database of FIG. 11, when compared to the same form being represented in HTML.

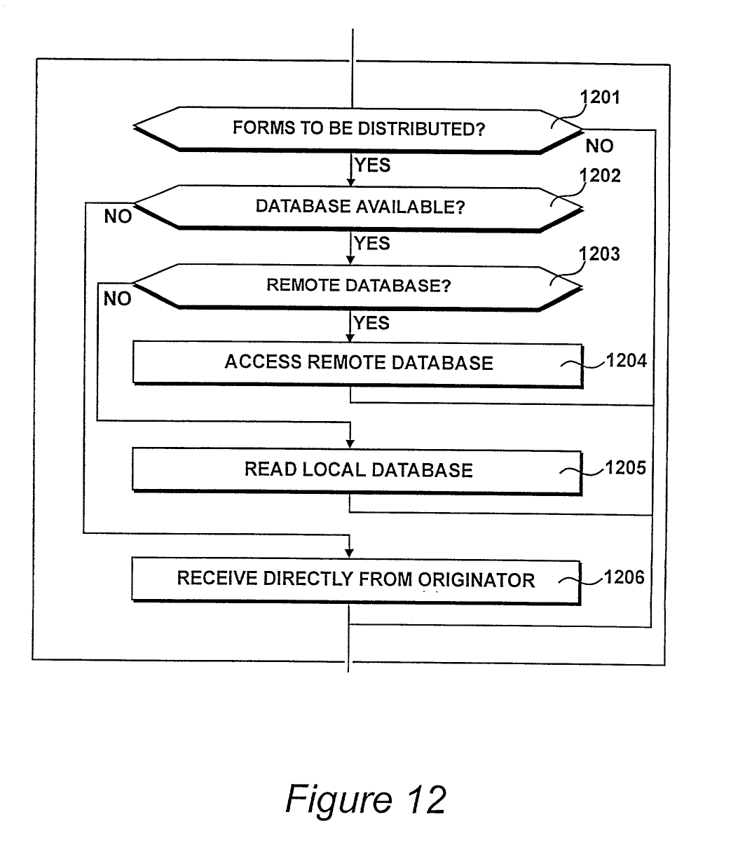

After the database of FIG. 11 has been populated, details of recipients (ie potential respondents) are appended under control of the procedures detailed in FIG. 12.

In the preferred embodiment of the invention, a list of respondents is included. Alternatively, details of the form may be supplied to the server without a list of respondents. Under these conditions, the form is incorporated into a Website and then details of the Website are provided using alternative means. Under these circumstances, the form is considered to be available to anyone and transmission from the server to the respondents may be considered as a broadcast.

At step 1201 a question is asked as to whether the forms are to be distributed with a list of respondents or to be broadcast and thereby made available without a specific list of respondents. If the question at step 1201 is answered in the negative, to the effect that the form is to be broadcast, no further action is taken at step 704 and the data is then compressed and encrypted for transmission at step 705.

If the question asked at step 1201 is answered in the affirmative, to the effect that the forms are to be distributed to respondents, a question is asked at step 1202 as to whether a database is available. If the question is answered in the affirmative, a further question is asked at step 1203 as to whether the database is remote. If this question is answered in the affirmative, to the effect that it is necessary to access a remote database, the database access is performed at step 1204 in order to obtain the necessary information. Thus, a process of this type would be performed by originator 109, where the database information is derived from server 108.

If the question asked at step 1203 is answered in the negative, to the effect that the database is not remote and is therefore local, the local database is read at step 1205. An operation of this type will be performed by originator 102.

If the question asked at step 1202 is answered in the negative to the effect that there is no database available, an originator is invited to directly enter recipient details at step 1206.

To summarise, a form database, specifying the nature of the form, may be transmitted to the distribution server 131 in one of four styles:

i. Broadcast style—no database of recipients.

ii. Small list of recipients—obtained by manually entering recipient details.

iii. Medium-sized recipient list—probably derived from a local database.

iv. Large distribution list—probably derived from a remote database.

Thus, after detailing the recipients, the combined file is compressed and encrypted at step 705 and then transmitted to the server at step 706.

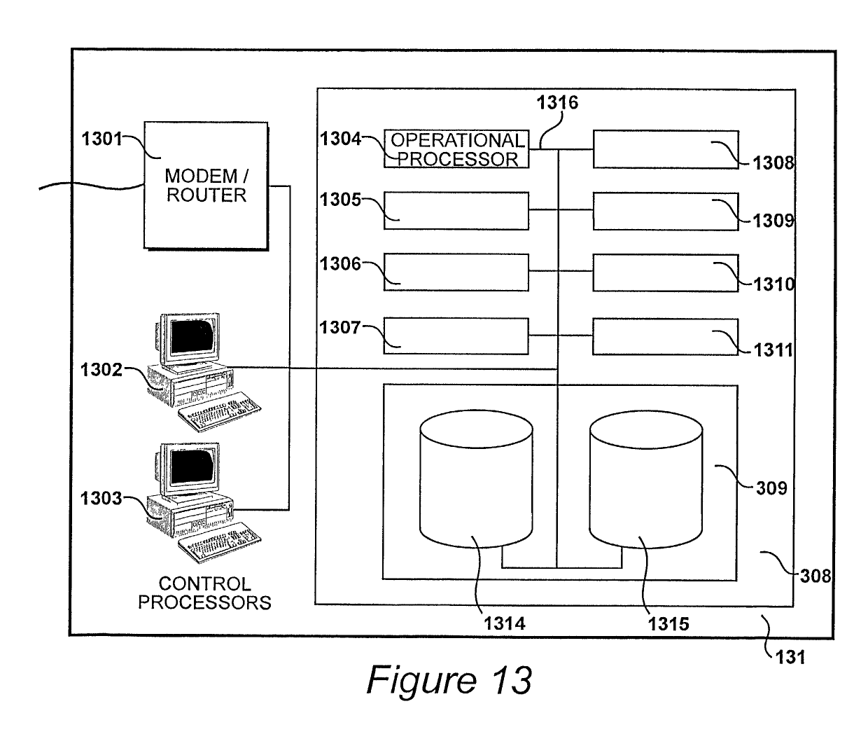

Distribution server 131 is detailed in FIG. 13. Communications with the World Wide Web 101 over transmission link 132 is effected via a high bandwidth modem/router 1301. Internally, the router 1301 communicates with a plurality of processors configured to operate in parallel. Two control stations 1302 and 1303 are provided, having visual display units and keyboards to allow operator intervention. In addition, a plurality of operational processors 1304, 1305, 1306, 1307, 1308, 1309, 1310 and 1311 are provided, along with two large storage volumes 1314 and 1315. The router, control processors, operational processors and storage volumes communicate via a high bandwidth network 1316, the nature and topology of which may vary in order to provide requisite bandwidth, with the connection shown in FIG. 13 being merely illustrative.

Transmission of form design applications is controlled and handled by the control processors 1302 and 1303. These control processors also deal with the transmission of data back to form originators. In addition, they schedule the generation of enquiries with respondents, with individual jobs being allocated to an operational processor. Thus, referring to FIG. 2, each operational processor is only concerned with operating on one specific campaign at a time and does not need to be familiar with specific originators and their degree of access; these being operations controlled by the control processors.

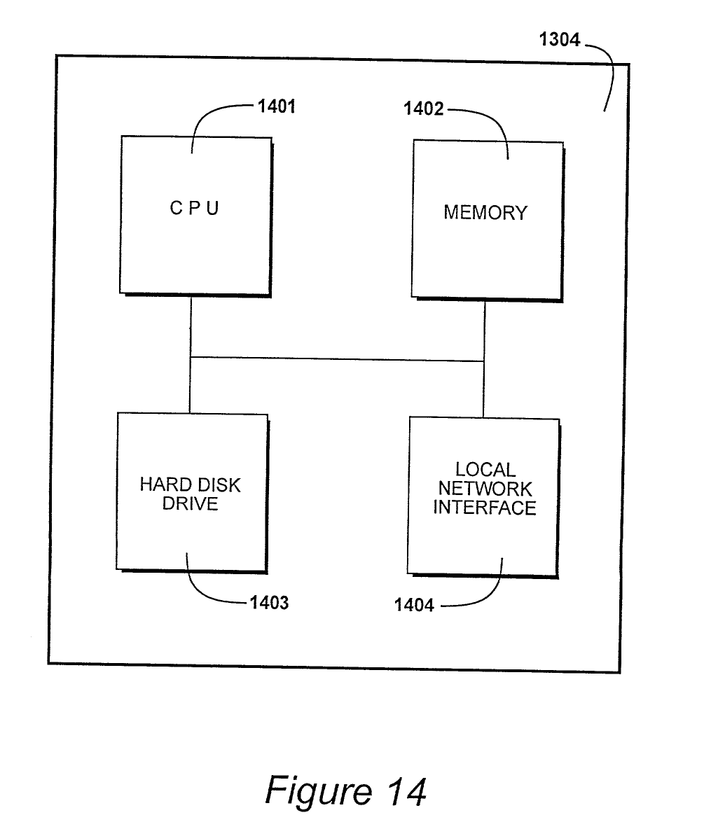

The hardware constituents of operational processor 1304 are detailed in FIG. 14. The processor includes a central processing unit 1401, local randomly accessible memory 1402, a hard disk drive 1403 and a local network interface 1404.

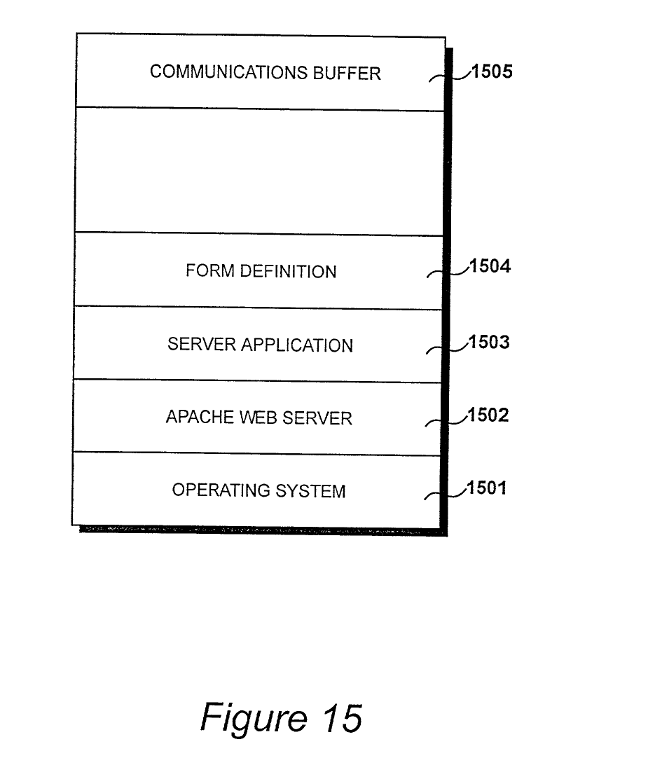

A summary of executable instructions and data stored within memory 1402 is identified in FIG. 15. This includes an operating system 1501 such as Microsoft NT Server and an appropriate Web server 1502. The server application held is at 1503 and does not change until a server application upgrade has been made. In this respect, an upgrade to the server application must be consistent with any upgrades made to the originator's application, given that the form components, identified by reference types, must be consistent.

For a particular job, a specific form definition is defined at 1504 and a communications buffer 1505 is established for communications with respondents.

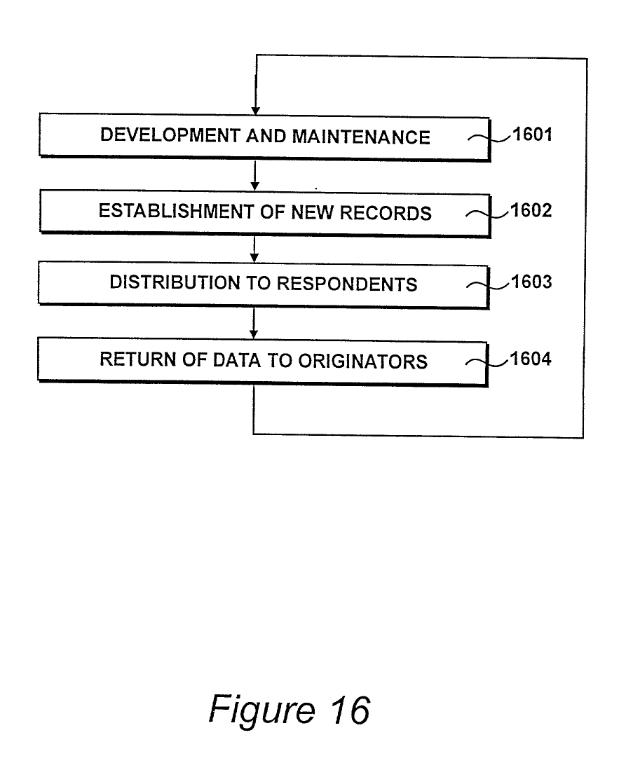

Operations performed within the server as a whole are summarised in FIG. 16. At step 1601, development and maintenance operations are performed on the server, possibly to upgrade server application instructions.

At step 1602 new records are established, which takes the form of receiving a particular form and distribution list from an originator and processing this as an individual job.

At step 1603 a job established at step 1602 is distributed to respondents.

At step 1604, data is returned to originators.

The procedures shown in FIG. 16 identify broad operational areas of the server. However, it should be appreciated that many operations of this type are multiplexed in parallel and the redundancy of the system ensures that one part may continue to operate while other parts of the server are being upgraded or maintained.

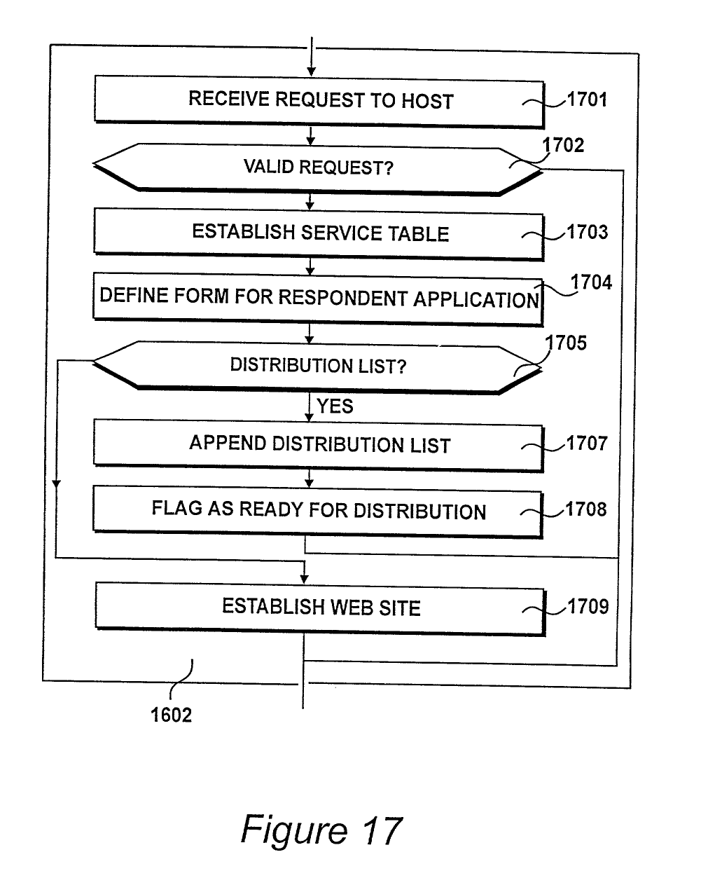

Procedures 1602 for the establishment of new records are detailed in FIG. 17.

At step 1701 a request to host a campaign is identified and at step 1702 a question is asked as to whether the request detected at step 1701 is valid. In terms of the validity of a request, it would be necessary for an originator to register with the distribution server and effectively open an account. Furthermore, different charging scales may be applied for sizes of distributions such that a check is firstly made as to whether the originator is known and then a second check is made to determine whether the size of the campaign is consistent with the level of service provided to that particular originator.

At step 1703 a service table is established for the job and at step 1704 a form is defined that can be completed by a respondent in response to procedures being executed on the respondent's computer.

At step 1705 a question is asked as to whether a distribution list exists and if answered in the affirmative, the distribution list is appended at step 1707 in non-compressed form and the job is then flagged at step 1708 as being ready for distribution.

If a distribution list is not available, the question asked at step 1705 is answered in the negative and a Web site for broadcasting purposes is established at step 1709.

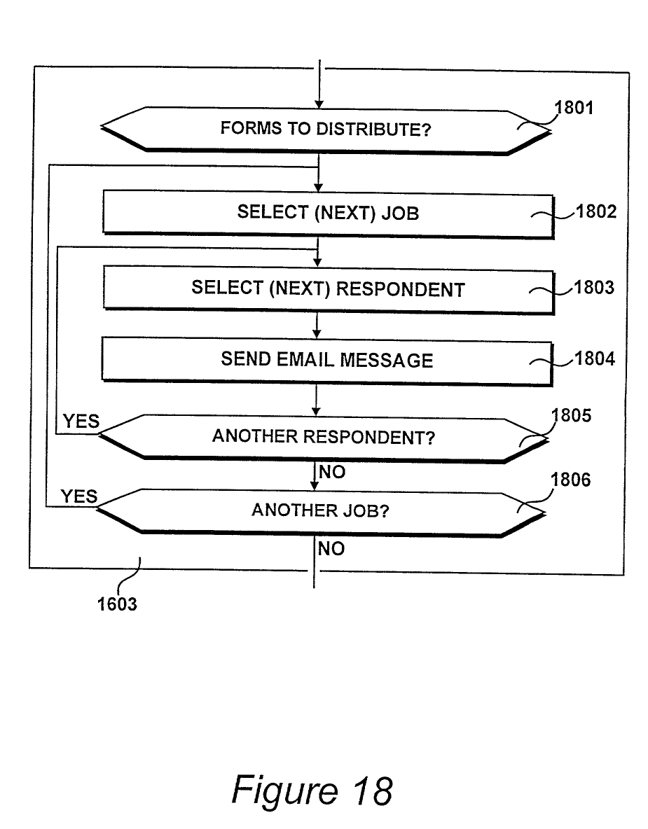

Procedures 1603 for the distribution of e-mail messages to respondents are detailed in FIG. 18. At step 1801 a question is asked as to whether forms are to be distributed and at step 1802 a job is selected. The selection of jobs is performed on a control processor 1302 and upon selection, details are transferred to an operational processor, such as processor 1304. At the operational processor, the next respondent is selected at step 1803 and an appropriate e-mail message is sent at step 1804. A question is asked at step 1805 as to whether another respondent exists and when answered in the affirmative control is returned to step 1803. When answered in the negative, to the effect that e-mails have been sent to all respondents, the question asked at step 1805 is answered in the negative and a question is asked at step 1806 as to whether another job is to be processed. When answered in the affirmative, control is returned to step 1802 and the next job is selected.

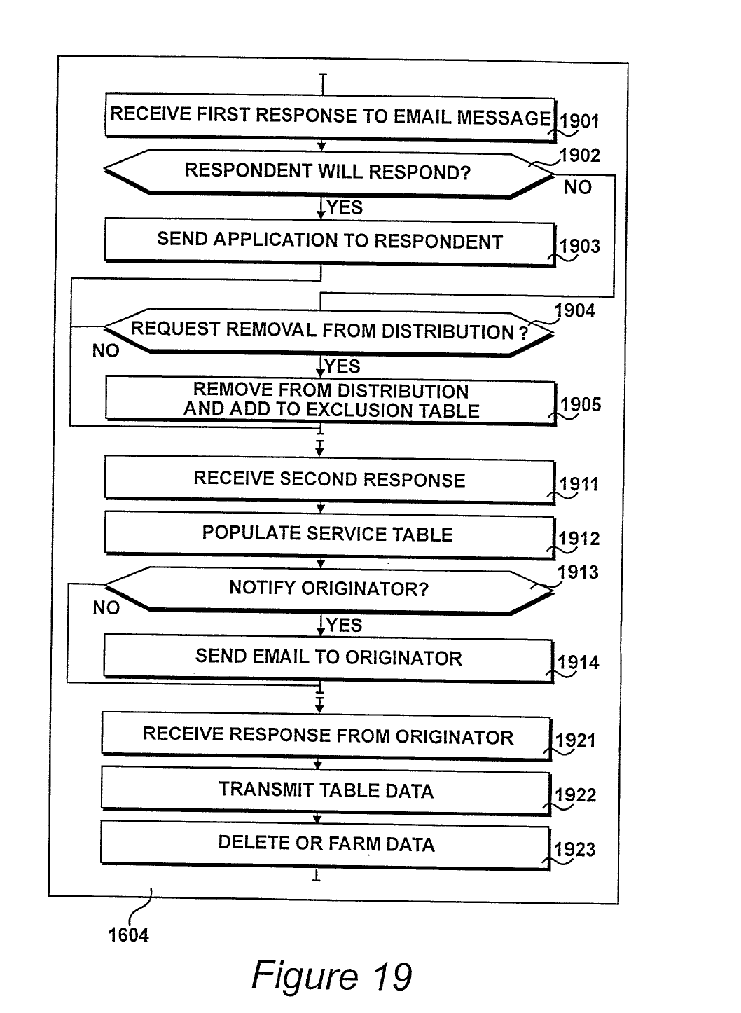

Procedures 1604 for processing data returned back from respondents is detailed in FIG. 19. At step 1804 an e-mail message is generated enquiring as to whether a potential respondent is prepared to respond. When responses to this message are made, they are caught at step 1901 whereafter a question is asked at step 1902 as to whether the respondent is prepared to respond. If the question asked at step 1902 is answered in the affirmative, a respondent Java Applet, generic to all forms, is supplied at step 1903 with the specific form definition generated at step 1704. In response to receiving the Applet and the form specific data, a Java interpreter at the respondent's terminal will effectively reconstitute a form of the type shown in FIG. 10. This will allow responses to be entered by the respondent, whereafter the information is returned back to the server in the form of a second response.

In an alternative embodiment, forms are created during execution of a file presentation generated under the software licensed by Macromedia Inc under the trademark “FLASH”. These FLASH files communicate with the server side application that in turn interfaces with a database. Under FLASH terminology, the application may be considered as “middlewear”.

A form displayed by a FLASH file may receive user data via editable text fields. The load variables or GetURL can send data (GET or POST) to the middlewear so as to format the data.

Using FLASH in this way provides greater flexibility in terms of the form designs and their display environment. A form is one or more editable text fields into which a user can enter information. Each field has a unique variable name that matches similar names in the middlewear application.

Forms sent out to respondents may include digital signatures, thereby enabling a respondent to confirm the identity of the respondent absolutely to the originator.

If the question asked at step 1902 is answered in the negative, a question is asked at step 1904 as to whether the respondent has requested to be removed from the distribution. If this question is answered in the affirmative, details of the respondent are removed from the distribution and details are added to an exclusion table at step 1905. The exclusion table is then interrogated during subsequent distributions to ensure that the particular respondent, such as respondent 216, does not receive any further communications from the originator concerned.

At step 1911 the server receives a second response taking the form of a populated form. At step 1912 the service table established at step 1703 is populated. In this way, responses received from all of the respondents are combined together in a database table. From this, in combination with the form table shown in FIG. 11, it is possible to analyse the information and produce appropriate reports.

At step 1913 a question is asked as to whether the originator is to be notified and when answered in the affirmative, an e-mail is sent to the originator identifying the fact that a previously specified number of responses have been received.

At step 1921 a response is received from the originator to the effect that the originator does require information to be transferred. The table data is transmitted to the originator at step 1922 whereafter the table data is deleted or farmed to data farm 133 at step 1923.

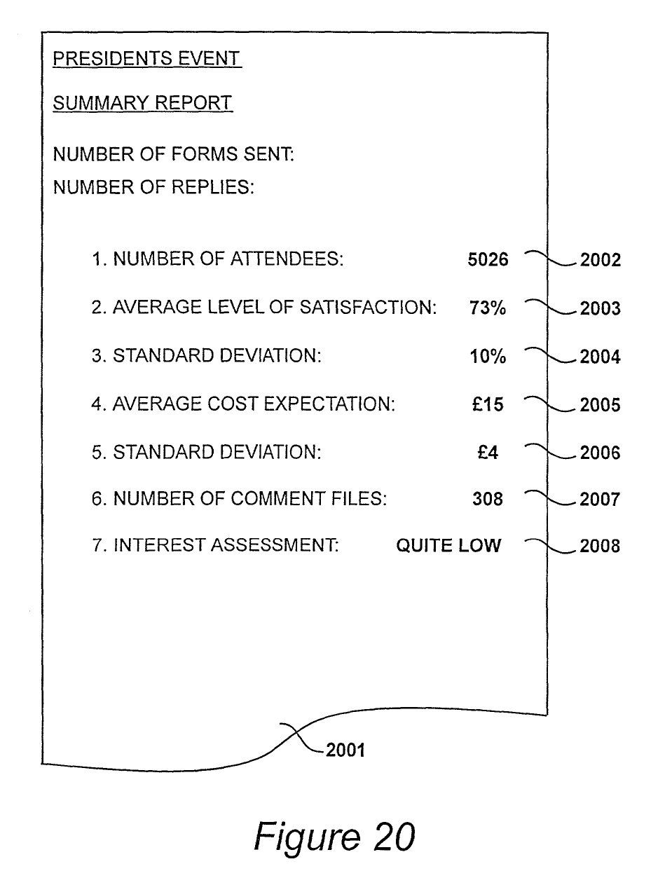

At the originator, the originator application receives the service table (in compressed and encrypted form) and performs decompression and decryption. The originator's application also includes the procedures for manipulating the data, in combination with the form table to produce summary reports. An example of a summary report 2001 generated by an originator's application is illustrated in FIG. 20. The summary report has been produced after six thousand respondents had received the form illustrated in FIG. 10 and five thousand and twenty six had replied. On this occasion, the response rate was high but on other occasions the level of response may itself provide useful information.

At line 2002 the process had deduced that out of six thousand invitations there were seven hundred and twenty five attendees. The average level of satisfaction was seventy-three percent as shown at 2003 with a standard deviation of ten percent as shown at 2004. At 2005 the average cost expectation is specified at fifteen pounds and at 2006 the standard deviation of this value is given at four pounds. At 2007 it is noted that of the seven hundred and twenty five attendees only three hundred and eight made comments. The procedures have deduced that with this represents a relatively low number of comments therefore the level of interest has been assessed as being quite low.

Thus, it can be seen that with very minimal effort on the part of originators and with significant technical assistance being provided on the part of the distribution server, it is possible to obtain valuable statistical marketing information. For example, in this modest specific example, the marketing department may deduce that for the event considered, the interest level is low and therefore this needs to be addressed if optimum benefit is to be derived from an advertising perspective. However, the department has only been charging four pounds per visit and the assessment would suggest that this could be increased to fifteen pounds without reducing the attendance level. The marketing assessment would therefore suggest that more should be charged for the event but that the event should be made more interesting. This valuable information has been obtained as a result of an admin clerk spending two hours defining the specific form in combination with modest charges received from the distribution server.

1. Serving apparatus configured to collect information from respondents so as to supply said information back to originators, comprising
reception means for receiving details of a form and a list of potential respondents from a plurality of originators;
construction means for constructing a plurality of individual invitations based on a said list of potential respondents respectively for each of said plurality of originators; and
supply means for supplying each invitation to potential respondents inviting said potential respondents to complete a form of a type generated by a respective originator; wherein
said reception means receives first responses from actual respondents, some of which affirm an acceptance to complete a form;
said supply means supplies a displayable form to each of said actual respondents;
said reception means receives second responses from said actual respondents containing response data;
storage means stores said response data from respondents; and
return means returns collected information to respective originators.

2. Serving apparatus according to claim 1, wherein details of said second responses are stored in a database.

3. Apparatus according to claim 2, wherein said database defines form components and the position of said components on a form.

4. Apparatus according to claim 1, wherein individual invitations are constructed as plain text e-mails and/or HTML messages.

5. Apparatus according to claim 1, wherein said supply means supplies a displayable form as a Java Applet.

6. Apparatus according to claim 1, wherein said supply means supplies a displayable form by incorporation of form related instructions within a FLASH file.

7. Apparatus according to claim 1, wherein a list of potential respondents is read from an originator's database.

8. Apparatus according to claim 1, wherein said return means returns collected information to originators as a single message containing response data from a plurality of respondents.

9. Serving apparatus configured to collect information from respondents so as to supply said information back to originators, comprising
reception means for receiving details of an originator's form and a list of potential respondents;
construction means for constructing a plurality of individual invitations based on a said list of potential respondents; and
supply means for supplying an invitation to each potential respondent inviting said potential respondent to complete an originator's form or to express a desire to be excluded from subsequent distributions; wherein
said reception means receives first responses from first respondents affirming an acceptance to complete a form;
said supply means supplies a displayable form to each of said first respondents;
said reception means receives second responses from second respondents identifying a desire to be excluded; and
details of said second respondents are identified in an exclusion database.

10. Apparatus according to claim 9, in which said exclusion database is interrogated before supplying invitations to potential respondents and potential respondents identified in said exclusion database are removed from said list.

11. Serving apparatus configured to collect information from respondents, comprising
a receiver for receiving details of a form and a list of potential respondents;
a supplier for supplying a displayable form to each respondent as a FLASH presentation;
a receiver for receiving response data from said respondents after said respondents have completed a form; and
storage means for storing said response data.

12. Apparatus according to claim 11, wherein said supply means sends an enquiry to a respondent, awaits a favourable response and then only transmits said displayable form if a favourable response is received.

13. A method of collecting information from respondents so as to supply said information back to originators, comprising the steps of
receiving details of a form and a list of potential respondents from a plurality of originators;
constructing a plurality of individual invitations based on a respective list for each of said plurality of originators;
supplying each invitation to potential respondents inviting said potential respondents to complete a form of a type generated by a respective originator;
receiving first responses from actual respondents that affirm an acceptance to complete a form;
supplying data to allow a form to be displayed to each of said actual respondents;
receiving second responses from said actual respondents containing response data;
storing said response data from said actual respondents; and
returning said response data to respective originators.

14. A method according to claim 13, wherein said received second responses are represented as database entries of a database.

15. A method according to claim 13, wherein said database defines form components and the position of said components on a form.

16. A method according to claim 13, wherein individual invitations are constructed as plain text e-mails and/or HTML messages.

17. A method according to claim 13, wherein a displayable form is created as a Java Applet.

18. A method according to claim 13, wherein a displayable form is created as a FLASH file.

19. A method according to claim 13, wherein a list of potential respondents is read from an originator's database.

20. A method according to claim 13, wherein collected information is returned to an originator as a single message containing response data from a plurality of respondents.

21. A method of collecting information from respondents so as to supply said information back to originators, comprising
receiving details of an originator's form and a list of potential respondents;
constructing a plurality of individual invitations based on said list of potential respondents;
supplying an invitation to each potential respondent inviting said potential respondent to complete an originator's form or to express a desire to be excluded from subsequent distributions;
receiving first responses from first respondents affirming an acceptance to complete a form;
supplying a displayable form to each of said first respondents;
receiving second responses from second respondents identifying a desire to be excluded; and
identifying details of said second responses in an exclusion database.

22. A method according to claim 21, wherein said exclusion database is interrogated before supplying invitations to potential respondents and potential respondents identified in said exclusion database are removed from said list.

23. A method of collecting information from respondents so as to supply said information back to originators, comprising the steps of
receiving details of a form and a list of potential respondents;
supplying a displayable form to each respondent as part of a FLASH file;
receiving response data; and
storing said response data.

24. A method according to claim 22, wherein an enquiry is sent to a respondent and a displayable form is only sent to said respondent if a favourable response is received from said enquiry.

25. A computer readable medium having computer readable instructions executable by a computer such that, when executing said instructions, a computer will perform the steps of
receiving details of a form and list of potential respondents from a plurality of originators;
constructing a plurality of individual invitations based on a respective list for each of said plurality of originators;
supplying each invitation to potential respondents inviting said potential respondents to complete a form of a type generated by a respective originator;
receiving first responses from actual respondents that affirm an acceptance to complete a form;
supplying data to allow a form to be displayed to each of said actual respondents;
receiving second responses from said actual respondents containing response data;
storing said response data from said actual respondents; and
returning said response data to respective originators.

26. A computer readable medium having computer readable instructions executable by a computer such that, when executing said instructions, a computer will perform the steps of
receiving details of an originator's form and a list of potential respondents;
constructing a plurality of individual invitations based on said list of potential respondents;
supplying an invitation to each potential respondent inviting said potential respondent to complete an originator's form or to express a desire to be excluded from subsequent distributions;
receiving first responses from first respondents affirming an acceptance to complete a form;
supplying a displayable form to each of said first respondents;
receiving second responses from second respondents identifying a desire to be excluded; and
identifying details of said second responses in an exclusion database;

27. A computer readable medium having computer readable instructions executable by a computer such that, when executing said instructions, a computer will perform the steps of
receiving details of a form and a list of potential respondents;
supplying a displayable form to each respondent as part of a FLASH file;
receiving response data; and
storing said response data.

28. A computer readable medium having computer readable instructions according to claim 27, such that when executing said instructions, a computer will also perform the step of sending an enquiry to a respondent and then only sending a displayable form to said respondent if a favourable response is received from said enquiry.
